(19) United States
(12) Patent Application Publication
(10) Pub. No.: US 2026/0018706 A1
(43) Pub. Date: Jan. 15, 2026

(54) HIGH-VOLTAGE UPS BATTERY SYSTEM

(71) Applicant: LEOCH INTERNATIONAL HOLDING PTE. LTD., SINGAPORE (SG)

(72) Inventors: Wenyan JIANG, SINGAPORE (SG); Yongjun LI, SINGAPORE (SG); Zhen LIN, SINGAPORE (SG); Maoqiang GUO, SINGAPORE (SG); Yang LI, SINGAPORE (SG)

(21) Appl. No.: 19/333,402

(22) Filed: Sep. 19, 2025

Related U.S. Application Data
(63) Continuation of application No. PCT/CN2024/120838, filed on Sep. 24, 2024.

(30) Foreign Application Priority Data
Apr. 11, 2024 (CN) 202410433204.8

(51) Int. Cl. H01M 10/657; H01M 10/48; H01M 10/615; H01M 10/627; H01M 10/63; H02J 9/06

(52) U.S. Cl. CPC H01M 10/657; H01M 10/486; H01M 10/488; H01M 10/627; H01M 10/63; H02J 9/06; H01M 10/615

(57) ABSTRACT

Provided is a high-voltage UPS battery system. The system includes a battery casing, a cell mounted within the battery casing, and a heating base mounted within the battery casing and at a bottom end of the cell. The heating base is configured to selectively heat the cell.

### CROSS-REFERENCE TO RELATED APPLICATIONS

This application is a continuation of International Application No. PCT/CN2024/120838, filed on Sep. 24, 2024, which claims priority to Chinese Patent Applications No. 202410433204.8, filed on Apr. 11, 2024, which is hereby incorporated by reference in its entirety.

### FIELD

The present disclosure relates to the technical field of batteries, and in particular, to a high-voltage UPS battery system.

### BACKGROUND

In the related art, an Uninterruptible Power Supply (UPS) is an uninterruptible power supply with constant voltage and frequency characteristics, which contains an energy storage device and takes an inverter as a main component of the uninterruptible power supply.

In an existing high-voltage UPS battery, cells cannot be charged or discharged quickly and safely at low temperatures, which causes a certain loss to the use of a cell material.

Therefore, a high-voltage UPS battery system is provided to solve the above problem.

### SUMMARY

The present disclosure aims to at least solve one of the technical problems in the related art to some extent.

To this end, an objective of the present disclosure is to provide a high-voltage UPS battery system.

The high-voltage UPS battery system according to embodiments of the present disclosure includes: a battery casing; a cell mounted within the battery casing; and a heating base mounted within the battery casing and mounted at a bottom end of the cell. The heating base is configured to selectively heat the cell.

In the high-voltage UPS battery system according to the embodiments of the present disclosure, under a heating effect of the heating base, it can be ensured that the cell is heated at a low temperature. In this way, it is effectively ensured that the cell may be charged and discharged quickly and safely at the low temperature, ensuring a service life of the cell.

Additional aspects and advantages of the present disclosure will be provided in part in the following description, or will become apparent in part from the following description, or can be learned from practicing of the present disclosure.

### BRIEF DESCRIPTION OF THE DRAWINGS

FIG. 1 is a schematic view of an insertion connection between a heating base and a charging plug of a high-voltage UPS battery system according to an embodiment of the present disclosure;

FIG. 2 is a schematic view of disengagement between a heating base and a charging plug of a high-voltage UPS battery system according to an embodiment of the present disclosure;

FIG. 3 is a partially schematic top view of a structure of an electric slide block and a sliding table according to an embodiment of the present disclosure;

FIG. 4 is a schematic enlarged view of part A in FIG. 1;

FIG. 5 is a schematic enlarged view of part B in FIG. 2; and

FIG. 6 is a schematic enlarged view of part C in FIG. 4.

### DETAILED DESCRIPTION

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

A high-voltage UPS battery system according to the embodiments of the present disclosure will be described in detail below with reference to the accompanying drawings.

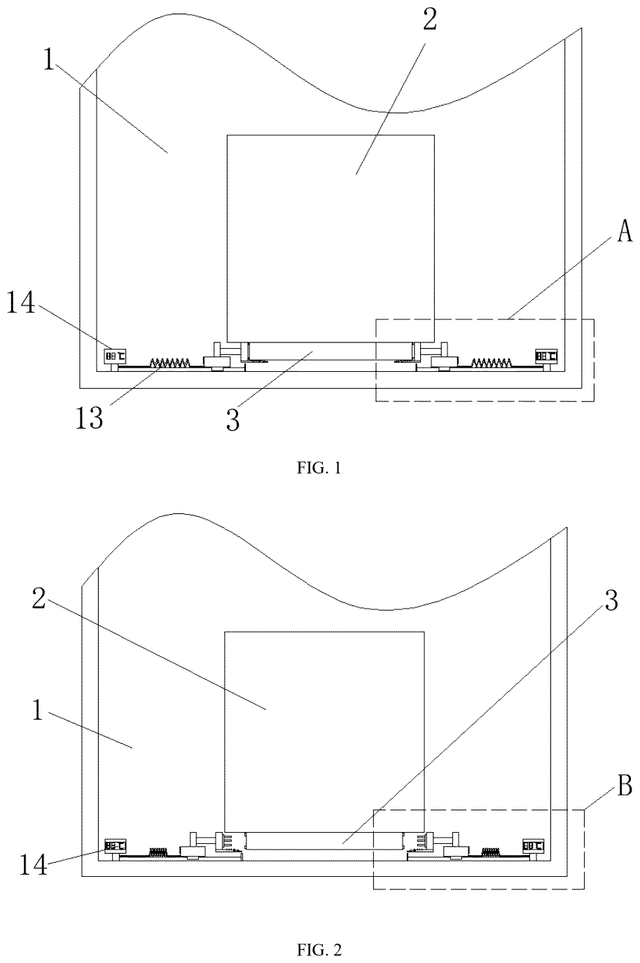

As shown in FIG. 1 to FIG. 6, the high-voltage UPS battery system according to the embodiments of the present disclosure includes a heating base 3, a battery casing 1, and a cell 2. The cell 2 is mounted within the battery casing 1. The heating base 3 is mounted within the battery casing 1 and at a bottom end of the cell 2. The heating base 3 is configured to selectively heat the cell 2.

When a temperature inside the battery casing 1 is too low, the heating base 3 is controlled to heat the cell 2. Under a heating effect of the heating base 3, it can be ensured that the cell 2 is heated at a low temperature. In this way, it is effectively ensured that the cell 2 may be charged and discharged quickly and safely at the low temperature, a service life of the cell 2. When the temperature inside the battery casing 1 reaches a certain value, the heating base 3 is controlled not to heat the cell 2.

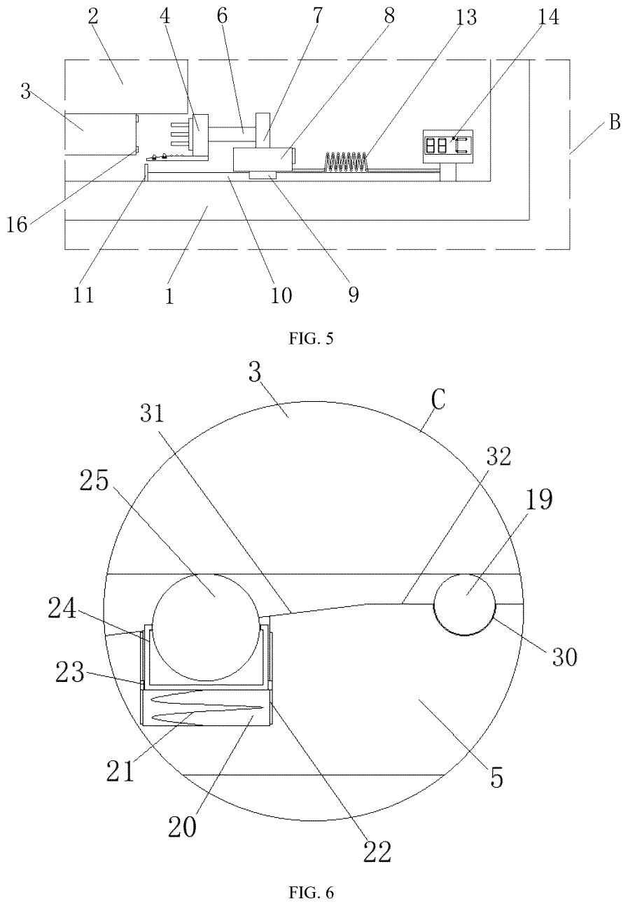

In some examples of the present disclosure, as shown in FIG. 4 and FIG. 5, the high-voltage UPS battery system may further include a sliding table 10, an electric storage plate-like block 8, and a charging plug 4. The sliding table 10 is fixedly disposed within the battery casing 1. The electric storage plate-like block 8 is slidably disposed at the sliding table 10, and the charging plug 4 is fixedly disposed at the electric storage plate-like block 8 and electrically connected to the electric storage plate-like block 8. The heating base 3 has a charging port corresponding to the charging plug 4. The electric storage plate-like block 8 is configured to drive the charging plug 4 to move along the sliding table 10 towards or away from the heating base 3, enabling the charging plug 4 to inserted into or pulled the charging plug 4 out of the charging port.

The sliding table 10, the electric storage plate-like block 8, and the charging plug 4 may each be disposed at a side part of the heating base 3. The sliding table 10 extends in an insertion direction of the heating base 3 and the charging plug 4, and is fixedly disposed within the battery casing 1. The electric storage plate-like block 8 is slidably disposed at the sliding table 10. The charging plug 4 is fixedly disposed at the electric storage plate-like block 8, is electrically connected to the electric storage plate-like block 8, and is arranged opposite to the charging port of the heating base 3. When the temperature inside the battery casing 1 is too low, the electric storage plate-like block 8 is controlled to drive the charging plug 4 to move along the sliding table 10 towards the heating base 3, enabling the charging plug 4 to inserted into the charging port, completing a charging and heating operation for the heating base 3. When the temperature inside the battery casing 1 reaches the certain value, the electric storage plate-like block 8 is controlled to drive the charging plug 4 to move along the sliding table 10 away from the heating base 3 to pull the charging plug 4 out of the charging port.

In some examples of the present disclosure, as shown in FIG. 4 and FIG. 5, the high-voltage UPS battery system may further include an electrical connection frame fixedly disposed at the electric storage plate-like block 8. The charging plug 4 is fixedly disposed at the electrical connection frame to electrically connect the charging plug 4 and the electric storage plate-like block 8. The charging plug 4 is fixedly disposed at the electric storage plate-like block 8 through the electrical connection frame, and the electrical connection frame may conduct electricity. In this way, the charging plug 4 can be electrically connected to the electric storage plate-like block 8, and the electric storage plate-like block 8 supplies power to the charging plug 4 through the electrical connection frame.

In some examples of the present disclosure, as shown in FIG. 4 and FIG. 5, the electrical connection frame includes a power transmission rod 6 and a conductive rod 7. The conductive rod 7 is fixedly mounted at a top end of the electric storage plate-like block 8, the power transmission rod 6 is fixedly disposed at the conductive rod 7, and the charging plug 4 is fixedly disposed at the power transmission rod 6. The conductive rod 7 is fixedly mounted at a middle part of the top end of the electric storage plate-like block 8. The power transmission rod 6 is fixedly disposed at a side wall of the conductive rod 7, and the power transmission rod 6 and the conductive rod 7 may be perpendicular to each other. The power transmission rod 6 extends towards the heating base 3. An end of the power transmission rod 6 is fixedly connected to the conductive rod 7, and the charging plug 4 is fixedly disposed at another end of the power transmission rod 6. This arrangement enables the charging plug 4 to be disposed at a position opposite to the heating base 3.

In some examples of the present disclosure, as shown in FIG. 4 and FIG. 5, the high-voltage UPS battery system may further include an electric slide block 9 fixedly connected to the electric storage plate-like block 8, and the electric storage plate-like block 8 is slidably disposed at the sliding table 10 through the electric slide block 9. The electric slide block 9 may be disposed below the electric storage plate-like block 8 and fixedly connected to the electric storage plate-like block 8. The electric slide block 9 is slidably disposed at the sliding table 10. When the electric slide block 9 moves along the sliding table 10, the electric slide block 9 may drive the electric storage plate-like block 8 to move synchronously.

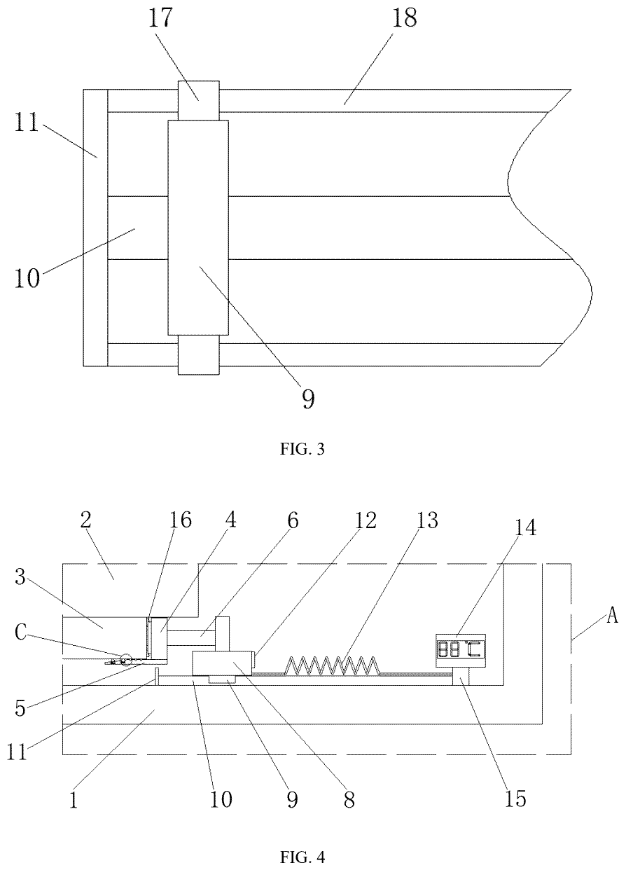

In some examples of the present disclosure, as shown in FIG. 3, the battery casing 1 is internally provided with a slide rod 18 extending in a movement direction of the electric storage plate-like block 8, and the electric slide block 9 is fixedly mounted with a slider 17. The slider 17 is slidably disposed at the slide rod 18. The slide rod 18 is parallel to the sliding table 10, and the slider 17 is slidably connected to an outer wall of the slide rod 18. When the electric storage plate-like block 8 moves, under a sliding effect the slider 17 and the slide rod 18, stability of the charging plug 4 is further improved in a process of the charging plug 4 moving to be connected to the heating base 3 in an insertion manner for charging.

In some examples of the present disclosure, as shown in FIG. 3 to FIG. 5, the high-voltage UPS battery system may further include a limiting top plate 11. The limiting top plate 11 is fixedly disposed within the battery casing 1 and abuts against an inner end of the sliding table 10. The slide rod 18 is fixedly connected to the limiting top plate 11.

The inner end of the sliding table 10 refers to an end of the sliding table 10 close to the heating base 3 in an extending direction of the sliding table 10. The limiting top plate 11 is mounted with the sliding table 10 and abuts against the inner end of the sliding table 10. When the electric storage plate-like block 8 drives the charging plug 4 to move towards the heating base 3 and abuts against the limiting top plate 11, under a limiting effect of the limiting top plate 11, it is possible to intuitively and effectively prevent the electric storage plate-like block 8 from moving excessively and falling off the sliding table 10. The inner end of the slide rod 18 is mounted at the limiting top plate 11, so that the slide rod 18 is fixedly disposed in the battery casing 1.

In some examples of the present disclosure, as shown in FIG. 4 and FIG. 5, the high-voltage UPS battery system may further include a temperature sensing display 14 and a signal switch 12. The temperature sensing display 14 is fixedly disposed within the battery casing 1. The signal switch 12 is disposed within the battery casing 1 and in communication connection with each of the temperature sensing display 14 and the electric storage plate-like block 8.

The temperature sensing display 14 is configured to sense a temperature inside the battery casing 1. An output end of the temperature sensing display 14 is connected to an input end of the signal switch 12 through a signal, and a signal input end of the electric storage plate-like block 8 is connected to a signal output end of the signal switch 12 through a signal. When the temperature inside the battery casing 1 is too low, in response to the temperature sensing display 14 sensing that the temperature is too low, the signal switch 12 is controlled to start. Under a starting effect of the signal switch 12, the electric storage plate-like block 8 is driven, to drive the charging plug 4 at a top end of the sliding table 10 to be inserted into a charging port at an outer side wall of the heating base 3, completing the charging and heating operation. A signal connection between the temperature sensing display 14, the signal switch 12, and the electric storage plate-like block 8 is a direct application of existing common technologies, and details are omitted herein.

When the temperature inside the battery casing 1 reaches the certain value, the charging plug 4 is driven by the electric storage plate-like block 8 to move outwards, releasing a charging operation between the charging plug 4 and the heating base 3, and to reset and retract. In some examples of the present disclosure, as shown in FIG. 4 and FIG. 5, the battery casing 1 is fixedly provided with a support rod 15 at an inner bottom wall of the battery casing 1, and the temperature sensing display 14 is fixedly disposed at the support rod 15. A top end of the support rod 15 is mounted at a bottom end of the temperature sensing display 14, the support rod 15 is located at a side of the sliding table 10 away from the limiting top plate 11, and an end of the sliding table 10 away from the limiting top plate 11 is fixedly connected to the support rod 15. The support rod 15 may reliably support the temperature sensing display 14, enabling the temperature sensing display 14 to be stably mounted within the battery casing 1.

In some examples of the present disclosure, as shown in FIG. 4 and FIG. 5, the high-voltage UPS battery system may further include a tension spring 13. The support rod 15 is opposite to the electric storage plate-like block 8 and located at a side of the electric storage plate-like block 8 away from the heating base 3. The tension spring 13 is connected between the electric storage plate-like block 8 and the support rod 15 and configured to drive the electric storage plate-like block 8 to drive the charging plug 4 to reset.

The support rod 15 and the electric storage plate-like block 8 are arranged opposite to each other in the extending direction of the sliding table 10, and the support rod 15 is located at the side of the electric storage plate-like block 8 away from the heating base 3. An end of the tension spring 13 is connected to the electric storage plate-like block 8, and another end of the tension spring 13 is connected to the support rod 15.

When the temperature inside the battery casing 1 is too low, in response to the temperature sensing display 14 sensing that the temperature is too low, the signal switch 12 is controlled to start. Under the starting effect of the signal switch 12, the electric storage plate-like block 8 is driven, to drive the charging plug 4 at the top end of the sliding table 10 to be inserted into the charging port at the outer side wall of the heating base 3, completing the charging and heating operation. At the same time, the tension spring 13 is stretched. When the temperature inside the battery casing 1 reaches the certain value, the charging plug 4 is driven by the electric storage plate-like block 8 to move outwards. After the charging operation between the charging plug 4 and the heating base 3 is released, under an elastic potential energy of the tension spring 13, the electric storage plate-like block 8 is driven, to reset and retract the charging plug 4.

In some examples of the present disclosure, as shown in FIG. 4 and FIG. 5, the heating base 3 is provided with an anti-collision pad 16 at an end surface of the heating base 3 facing the charging plug 4, and the anti-collision pad 16 is configured to abut against the charging plug 4. The end surface of the heating base 3 facing the charging plug 4 is glued with the anti-collision pad 16, and the electric storage plate-like block 8 drives the charging plug 4 to be inserted into the charging port at the outer side wall of the heating base 3. When the anti-collision pad 16 may abut against the charging plug 4, the anti-collision pad 16 may protect the charging plug 4 and the heating base 3, avoiding damage caused by collision.

In some examples of the present disclosure, as shown in FIG. 4 to FIG. 6, the charging plug 4 is fixedly mounted with a guide plate 5 at a bottom end of the charging plug 4, and the guide plate 5 extends towards the heating base 3. The guide plate 5 has a limiting groove 20 formed at a top end of the guide plate 5 and recessed inwardly towards the guide plate 5. A mounting frame 24 and a return spring 21 are mounted in the limiting groove 20. The return spring 21 is located between the mounting frame 24 and a bottom wall of the limiting groove 20, and two ends of the return spring 21 respectively abut against the mounting frame 24 and the bottom wall of the limiting groove 20. The mounting frame 24 is movable in a depth direction of the limiting groove 20 and is provided with a second ball 25 rollably embedded in the mounting frame 24, and the second ball 25 is adapted to abut against a bottom end of the heating base 3.

During the process that the charging plug 4 is driven by the electric storage plate-like block 8 to be inserted into the charging port of the heating base 3, when the guide plate 5 abuts against the heating base 3, under a guiding effect of the guide plate 5, the charging plug 4 may be stably and conveniently docked and inserted directly with a charging port at a side wall of the heating base 3. Moreover, after the second ball 25 abuts against the bottom end of the heating base 3, the second ball 25 is pressed to move towards the inside of the limiting groove 20. During an insertion process of the charging plug 4 and the heating base 3, under a rolling effect of the second ball 25, the guide plate 5 may stably abut against an outer wall of the bottom end of the heating base 3. After the charging plug 4 is driven by the electric storage plate-like block 8 to release the charging operation between the charging plug 4 and the heating base 3, the return spring 21 may drive the mounting frame 24 to drive the second ball 25 to reset.

In some examples of the present disclosure, as shown in FIG. 6, the mounting frame 24 is mounted with a slide block 23 at a side wall of the mounting frame 24. The limiting groove 20 is fixedly provided with a sliding rail 22 at an inner side wall of the limiting groove 20. The sliding rail 22 extends in the depth direction of the limiting groove 20, and the slide block 23 is slidably disposed at the sliding rail 22.

The mounting frame 24 is mounted with the slide block 23 at an outer side wall of the mounting frame 24. The slide block 23 may be mounted at each of two opposite side walls of the mounting frame 24. The limiting groove 20 is fixedly provided with a sliding rail 22 at the inner side wall of the limiting groove 20. The limiting groove 20 may be fixedly provided with a sliding rail 22 at each of two opposite inner side walls of the limiting groove 20. The slide block 23 is slidably disposed at the sliding rail 22. Through sliding engagement between the slide block 23 and the sliding rail 22, it is possible to guide a movement of the mounting frame 24, allow the mounting frame 24 and the second ball 25 to move in the depth direction of the limiting groove 20, and avoid deviation of the mounting frame 24 and the second ball 25.

In some examples of the present disclosure, as shown in FIG. 6, the guide plate 5 has a mounting groove 30 formed at the top end of the guide plate 5 and recessed inwardly towards the guide plate 5, and the mounting groove 30 is located at a side of the limiting groove 20 close to the charging plug 4. The mounting groove 30 is provided with a first ball 19 rollably embedded in the mounting groove 30. The first ball 19 is adapted to abut with the bottom end of the heating base 3.

During the process that the charging plug 4 is driven by the electric storage plate-like block 8 to be inserted into the charging port of the heating base 3, when the guide plate 5 abuts against the heating base 3, under the guiding effect of the guide plate 5, it is possible to enable the charging plug 4 to stably and conveniently be docked and inserted directly with the charging port at the side wall of the heating base 3. Moreover, after the first ball 19 abuts against the bottom end of the heating base 3, in combination with use of rolling abutment of the first ball 19, stability of a guiding movement of the guide plate 5 is ensured.

In some examples of the present disclosure, as shown in FIG. 6, the guide plate 5 has a guiding inclined surface 31 and a horizontal surface 32 that are formed at the top end of the guide plate 5. The guiding inclined surface 31 is adjacent to the horizontal surface 32. The horizontal surface 32 is located at a side of the guiding inclined surface 31 close to the charging plug 4. The guiding inclined surface 31 is inclined downwards in a direction from the horizontal surface 32 towards the guiding inclined surface 31. The limiting groove 20 corresponds to the guiding inclined surface 31. The mounting groove 30 corresponds to the horizontal surface 32. The guiding inclined surface 31 is connected to the horizontal surface 32, the limiting groove 20 is formed at the guiding inclined surface 31, and the mounting groove 30 is disposed at the horizontal surface 32. During the process that the charging plug 4 is driven by the electric storage plate-like block 8 to be inserted into the charging port of the heating base 3, the guiding inclined surface 31 may avoid the heating base 3, allowing the second ball 25 to abut against the bottom end of the heating base 3. Moreover, the mounting groove 30 is formed at the horizontal surface 32, enabling the first ball 19 to be disposed at the horizontal surface 32. After the first ball 19 abuts against the bottom end of the heating base 3, the stability of the guiding movement of the guide plate 5 is better ensured.

As shown in FIG. 1, FIG. 2, FIG. 3, FIG. 4, FIG. 5, and FIG. 6, in the embodiments of the present disclosure, the high-voltage UPS battery system includes the battery casing 1, the cell 2 mounted at a lower end of a middle part inside the battery casing 1, and the heating base 3 mounted at a middle part of the bottom end of the cell 2. The battery casing 1 is mounted with support rods 15 symmetrically at two sides of a bottom end of an inner wall of the battery casing 1, and top ends of the support rods 15 are each mounted at the bottom end of the temperature sensing display 14. The output end of the temperature sensing display 14 is connected to the input end of the signal switch 12 through a signal.

The support rod 15 is fixedly mounted with the sliding table 10 at a bottom end of an inner side wall of the support rod 15, and the electric storage plate-like block 8 is slidably connected to the top end of the sliding table 10. The signal input end of the electric storage plate-like block 8 is connected to the signal output end of the signal switch 12 through a signal. The electric storage plate-like block 8 is fixedly mounted with a conductive rod 7 at the middle part of the top end of the electric storage plate-like block 8, and the conductive rod 7 is fixedly mounted with a power transmission rod 6 at each of a middle part and an inner side wall of the conductive rod 7. A top end of an inner side of the power transmission rod 6 is fixedly mounted at a middle part of an outer side wall of the charging plug 4.

When the temperature inside the battery casing 1 is too low, in response to the temperature sensing display 14 sensing that the temperature is too low, the signal switch 12 is controlled to start. Under the starting effect of the signal switch 12, the electric storage plate-like block 8 is driven, to drive the charging plug 4 at the top end of the sliding table 10 to be inserted into the charging port at the outer side wall of the heating base 3, completing the charging and heating operation. The signal connection between the temperature sensing display 14, the signal switch 12, and the electric storage plate-like block 8 is the direct application of existing common technologies, and details are omitted herein.

Under the heating effect of the heating base 3, it can be ensured that the cell 2 is heated at a low temperature. In this way, it is effectively ensured that the cell 2 may be charged and discharged quickly and safely at the low temperature, ensuring the service life of the cell 2.

As shown in FIG. 3, the electric slide block 9 is fixedly mounted with the slider 17 at a middle part of each of a front side and a rear side of the electric slide block 9, and the slider 17 is slidably connected to the outer wall of the slide rod 18. An end of the slide rod 18 is mounted at each of a front side and a rear side of an inner side wall of the limiting top plate 11. A middle part of an inner wall of the limiting top plate 11 is mounted with the sliding table 10, and a bottom end of the limiting top plate 11 is mounted at the bottom end of the inner wall of the battery casing 1.

Under the sliding effect of the slider 17 and the slide rod 18, the stability of the charging plug 4 is further improved in the process of the charging plug 4 moving to be connected to the heating base 3 in an insertion manner for charging. Meanwhile, under the limiting effect of the limiting top plate 11, it is possible to intuitively and effectively prevent the electric storage plate-like block 8 from moving excessively.

As shown in FIG. 1 and FIG. 2, a tension spring 13 is welded to a bottom end of an outer side wall of the electric storage plate-like block 8, and an outer side wall of the tension spring 13 is welded to a middle part of the inner side wall of the support rod 15.

When the temperature inside the battery casing 1 reaches the certain value, the charging plug 4 is driven by the electric storage plate-like block 8 to move outwards. After the charging operation between the charging plug 4 and the heating base 3 is released, in combination with the elastic potential energy of the tension spring 13, the charging plug 4 may be further driven by the electric storage plate-like block 8 to reset and retract.

As shown in FIG. 4 and FIG. 5, an anti-collision pad 16 is glued to each of an upper end and a lower end of the outer side wall of the heating base 3, and outer side wall of the anti-collision pads 16 each abut against an upper end and a lower end of an outer wall of the inner side of the charging plug 4.

Under the protection effect of the anti-collision pad 16, the outer wall of the inner side of the charging plug 4 and the outer side wall of the heating base 3 are protected, avoiding the damage caused by collision.

As shown in FIG. 4, FIG. 5, and FIG. 6, the charging plug 4 is fixedly mounted with the guide plate 5 at the bottom end of the charging plug 4, and a plurality of sets of limiting grooves 20 are equidistantly formed at a top end of an inner side wall of the guide plate 5. A return spring 21 is welded to a bottom end of an inner wall of the limiting groove 20, and a top end of the return spring 21 is welded to a middle part of a bottom end of the mounting frame 24. The second ball 25 is rollably embedded in a middle part of a top end of the mounting frame 24, and the top end of the second ball 25 rollably abuts against the outer wall of the bottom end of the heating base 3. The mounting frame 24 is mounted with slide blocks 23 symmetrically at two sides of the bottom end of the mounting frame 24, and outer sides of the slide blocks 23 are each slidably connected to an inner side of the sliding rail 22. The sliding rails 22 are symmetrically formed at a middle part of the inner wall of the limiting groove 20.

Under the guiding effect of the guide plate 5, it is possible to enable the charging plug 4 to stably and conveniently be docked and inserted directly with the charging port at the side wall of the heating base 3. Moreover, under the rolling effect of the second ball 25, the guide plate 5 may stably abut against the outer wall of the bottom end of the heating base 3.

As shown in FIG. 6, first balls 19 are rollably embedded equidistantly at a top end of the guide plate 5 outside the second ball 25, and top ends of the first balls 19 each rollably abut against the outer wall of the heating base 3.

In combination with the use of rolling abutment of the first ball 19, the stability of the guiding movement of the guide plate 5 is ensured.

An operation principle is that when the temperature inside the battery casing 1 is too low, in response to the temperature sensing display 14 sensing that the temperature is too low, the signal switch 12 is controlled to start. Under the starting effect of the signal switch 12, the electric storage plate-like block 8 is driven, to drive the charging plug 4 at the top end of the sliding table 10 to be inserted into the charging port at the outer side wall of the heating base 3, completing the charging and heating operation.

In some examples of the present disclosure, two charging plugs 4, two guide plates 5, two power transmission rods 6, two conductive rods 7, two electric storage plate-like blocks 8, two electric slide blocks 9, two sliding tables 10, two limiting top plates 11, two signal switches 12, two tension springs 13, two temperature sensing displays 14, and two support rods 15 may be each provided. One charging plug 4, one guide plate 5, one power transmission rod 6, one conductive rod 7, one electric storage plate-like block 8, one electric slide block 9, one sliding table 10, one limiting top plate 11, one signal switch 12, one tension spring 13, one temperature sensing display 14, and one support rod 15 form a set of charging devices, and two sets of charging devices are disposed at two opposite sides of the heating base 3, respectively.

In the description of the present disclosure, it is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and location relations which are the directions and location relations shown in the drawings, and for describing the present disclosure and for describing in simple, and which are not intended to indicate or imply that the device or the elements are disposed to locate at the specific directions or are structured and performed in the specific directions, which could not to be understood to the limitation of the present disclosure.

In addition, terms such as “first” and “second” are used herein for purposes of description and are not intended to indicate or imply relative importance or significance. Therefore, the feature associated with “first” and “second” may comprise one or more this feature distinctly or implicitly. In the description of the present disclosure, “a plurality of” means two or more than two, unless specified otherwise.

In the present disclosure, unless specified or limited otherwise, the terms “mounted,” “connected,” “coupled” and “fixed” are understood broadly, such as fixed, detachable mountings, connections and couplings or integrated, and can be mechanical or electrical mountings, connections and couplings, and also can be direct and via media indirect mountings, connections, and couplings, and further can be inner mountings, connections and couplings of two components or interaction relations between two components, which can be understood by those skilled in the art according to the detail embodiment of the present disclosure.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

Throughout this specification, description with reference to “an embodiment”, “some embodiments”, “an example”, “a specific example”, “some examples”, or the like means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Further, the particular features, structures, materials, or characteristics described here may be combined in any suitable manner in one or more embodiments or examples. In addition, those skilled in the art can combine the different embodiments or examples and the features of the different embodiments or examples described in this specification without contradicting each other.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A high-voltage UPS battery system, comprising:
a battery casing;
a cell mounted within the battery casing; and
a heating base mounted within the battery casing and at a bottom end of the cell, the heating base being configured to selectively heat the cell.

2. The high-voltage UPS battery system according to claim 1, further comprising:
a sliding table fixedly disposed within the battery casing;
an electric storage plate-like block slidably disposed at the sliding table; and
a charging plug fixedly disposed at the electric storage plate-like block and electrically connected to the electric storage plate-like block,
wherein the heating base has a charging port corresponding to the charging plug, and wherein the electric storage plate-like block is configured to drive the charging plug to move along the sliding table towards or away from the heating base, enabling the charging plug to inserted into or pulled out of the charging port.

3. The high-voltage UPS battery system according to claim 2, further comprising:
an electrical connection frame fixedly disposed at the electric storage plate-like block, wherein the charging plug is fixedly disposed at the electrical connection frame to electrically connect the charging plug and the electric storage plate-like block.

4. The high-voltage UPS battery system according to claim 3, wherein the electrical connection frame comprises a power transmission rod and a conductive rod, wherein:
the conductive rod is fixedly mounted at a top end of the electric storage plate-like block;
the power transmission rod is fixedly disposed at the conductive rod; and
the charging plug is fixedly disposed at the power transmission rod.

5. The high-voltage UPS battery system according to claim 2, further comprising an electric slide block fixedly connected to the electric storage plate-like block, the electric storage plate-like block being slidably disposed at the sliding table through the electric slide block.

6. The high-voltage UPS battery system according to claim 5, wherein:
the battery casing is internally provided with a slide rod extending in a movement direction of the electric storage plate-like block; and
the electric slide block is provided with a slider fixedly mounted at the electric slide block, the slider being slidably disposed at the slide rod.

7. The high-voltage UPS battery system according to claim 6, further comprising a limiting top plate, wherein:
the limiting top plate is fixedly disposed within the battery casing;
the limiting top plate abuts against an inner end of the sliding table; and
the slide rod is fixedly connected to the limiting top plate.

8. The high-voltage UPS battery system according to claim 2, further comprising:
a temperature sensing display fixedly disposed within the battery casing; and
a signal switch disposed within the battery casing and in communication connection with each of the temperature sensing display and the electric storage plate-like block.

9. The high-voltage UPS battery system according to claim 8, wherein the battery casing is fixedly provided with a support rod at an inner bottom wall of the battery casing, the temperature sensing display being fixedly disposed at the support rod.

10. The high-voltage UPS battery system according to claim 9, further comprising a tension spring, wherein:
the support rod is opposite to the electric storage plate-like block and located at a side of the electric storage plate-like block away from the heating base; and
the tension spring is connected between the electric storage plate-like block and the support rod and configured to drive the electric storage plate-like block to drive the charging plug to reset.

11. The high-voltage UPS battery system according to claim 2, wherein the heating base is provided with an anti-collision pad at an end surface of the heating base facing the charging plug, the anti-collision pad being configured to abut against the charging plug.

12. The high-voltage UPS battery system according to claim 2, wherein:
the charging plug is fixedly mounted with a guide plate at a bottom end of the charging plug, the guide plate extending towards the heating base;
the guide plate has a limiting groove formed at a top end of the guide plate and recessed inwardly towards the guide plate;
a mounting frame and a return spring are mounted in the limiting groove, the return spring being located between the mounting frame and a bottom wall of the limiting groove, and two ends of the return spring respectively abutting against the mounting frame and the bottom wall of the limiting groove; and
the mounting frame is movable in a depth direction of the limiting groove and is provided with a second ball rollably embedded in the mounting frame, the second ball being adapted to abut against a bottom end of the heating base.

13. The high-voltage UPS battery system according to claim 12, wherein:
the mounting frame is mounted with a slide block at a side wall of the mounting frame;
the limiting groove is fixedly provided with a sliding rail at an inner side wall of the limiting groove, the sliding rail extending in the depth direction of the limiting groove, and the slide block being slidably disposed at the sliding rail.

14. The high-voltage UPS battery system according to claim 12, wherein:
the guide plate has a mounting groove formed at the top end of the guide plate and recessed inwardly towards the guide plate, the mounting groove being located at a side of the limiting groove close to the charging plug; and
the mounting groove is provided with a first ball rollably embedded in the mounting groove, the first ball being adapted to abut with the bottom end of the heating base.

15. The high-voltage UPS battery system according to claim 14, wherein the guide plate has a guiding inclined surface and a horizontal surface that are formed at the top end of the guide plate, wherein:
the guiding inclined surface is adjacent to the horizontal surface;
the horizontal surface is located at a side of the guiding inclined surface close to the charging plug;
the guiding inclined surface is inclined downwards in a direction from the horizontal surface towards the guiding inclined surface;
the limiting groove corresponds to the guiding inclined surface; and
the mounting groove corresponds to the horizontal surface.

16. The high-voltage UPS battery system according to claim 3, further comprising an electric slide block fixedly connected to the electric storage plate-like block, the electric storage plate-like block being slidably disposed at the sliding table through the electric slide block.

17. The high-voltage UPS battery system according to claim 4, further comprising an electric slide block fixedly connected to the electric storage plate-like block, the electric storage plate-like block being slidably disposed at the sliding table through the electric slide block.
